(19) United States
(12) Patent Application Publication
(10) Pub. No.: US 2026/0005767 A1
(43) Pub. Date: Jan. 1, 2026

(54) Integrated-Photonics Optical Processor (IPOP), Silicon Photonic Integrated Circuit Beamformer for RF Photonic Applications and Related Systems and Methods

(71) Applicant: Phase Sensitive Innovations, Inc., Newark, DE (US)

(72) Inventors: Timothy Creazzo, West Grove, PA (US); Garrett Schneider, New Castle, DE (US); Janusz Murakowski, Bear, DE (US); Christopher Schuetz, Avondale, PA (US); Shouyuan Shi, Newark, DE (US); Dennis Prather, Newark, DE (US)

(21) Appl. No.: 19/180,016

(22) Filed: Apr. 15, 2025

Related U.S. Application Data
(60) Provisional application No. 63/660,501, filed on Jun. 15, 2024.

(51) Int. Cl. H04B 10/2575; H01Q 3/26; H04B 10/50

(52) U.S. Cl. CPC H04B 10/25754; H01Q 3/2676; H04B 10/505; H04B 2210/006

(57) ABSTRACT

A semiconductor photonic integrated circuits (PICs) may perform RF signal processing, including beamspace processing or spatial Fourier Transforms in a semiconductor PIC. An RF imaging system including the semiconductor processing PIC may include an antenna array that upconverts RF signals to optical signals using electro-optic modulators, such as lithium niobate modulators. Simultaneous processing (beamforming) of multiple RF signals utilizing the semiconductor processing PIC may be performed.

### RELATED APPLICATIONS

This application is a non-provisional of U.S. Provisional Application No. 63/660,501 filed Jun. 15, 2024, the entire contents of which are hereby incorporated by reference.

### BACKGROUND

The processing of RF signals is integral in modern communications systems. With commercial implementation of 5G networks in full swing, service providers are continuing to strive to provide higher speed and lower latency data connections to meet customer demand. Accordingly, higher frequencies and more advanced techniques are being developed and implemented including mmWave and massive MIMO to enhance 5G capabilities. Furthermore, roadmaps, such as the one provided by 3GPP, have identified major enhancements in the areas of artificial intelligence (AI) and extended reality (XR) that are expected to be implemented in the 2025 time frame [1]. To support these advancements in future network technologies, the capabilities of the underlying hardware must also keep pace. The move to higher frequencies and higher bandwidths is putting a lot of stress on the ability of the corresponding RF components required to implement the advanced techniques. The field of radio-frequency-photonics (RF-photonics) may offer an opportunity to support the desired implementations of highly advanced network topologies not only in the near-term, but long into the future with wide frequency range and large bandwidth abilities that may have previously been considered as unattainable using solely RF technologies. For example, a phased array beamforming system based on optical techniques can offer unprecedented performance in terms of beam-bandwidth product with significantly lower power consumption [2]-[4]. Photonic integrated circuits (PICs) can be leveraged to reduce the size, weight and cost of implementing the aforementioned optical techniques in an RF-photonic system [5]. Silicon PICs in particular have already been used in some RF mmWave applications [6], and the use of highly integrated silicon PICs offers the potential to support more advanced optical processing, e.g., simultaneous spatial and spectral, with increased complexity while maintaining a small footprint [7], [8].

### SUMMARY

Embodiments herein relate to a semiconductor-photonic beamspace processing PIC, i.e. a beamforming PIC, and an RF-photonic imaging system including the same, and related methods of operation and manufacturing. The beamforming PIC may produce a unique output corresponding to the input angle-of-arrival of an RF wave. The beamforming PIC may be integrated into an RF-photonic imaging system may simultaneously process multiple RF signals incident on the antenna array of the system. RF Photonic systems with PICs disclosed herein may provide highly flexible and impactful to future 5G/6G systems.

### BRIEF DESCRIPTION OF THE DRAWINGS

FIG. 1 is a schematic of an RF Photonic phased array system with optical processing.

FIG. 2A illustrates an example of a packaged Si beamforming PIC on a breakout PCB; FIG. 2B illustrates the packaged PIC; FIG. 2C shows further details of the PIC. The PIC may include optical edge couplers for coupling light into and out of the PIC, and wire bonding may provide connections to the on-chip photodiodes and thermal phase shifters.

FIG. 3A is a schematic illustrating experimental setup for testing the beamforming PIC; FIG. 3B is an image from the IR camera showing a single beam formed at the output of the PIC corresponding to an RF signal with a particular angle of arrival; and FIG. 3C is another IR image for a different phase profile corresponding to a different output beam.

FIG. 4A is a block diagram of an RF Photonic imaging system with the Si Photonic PIC serving as the beamforming element of the system; FIG. 4B 64-QAM shows a constellation captured at the output of the PDTIA at an IF frequency of 1 GHz after beamforming through the PIC.

FIG. 5A is a block diagram the RF Photonic imaging system using the PIC for simultaneous beamforming of 2 RF signals; FIG. 5B illustrates IF Constellations captured at the output of the system for both RF sources.

### DETAILED DESCRIPTION

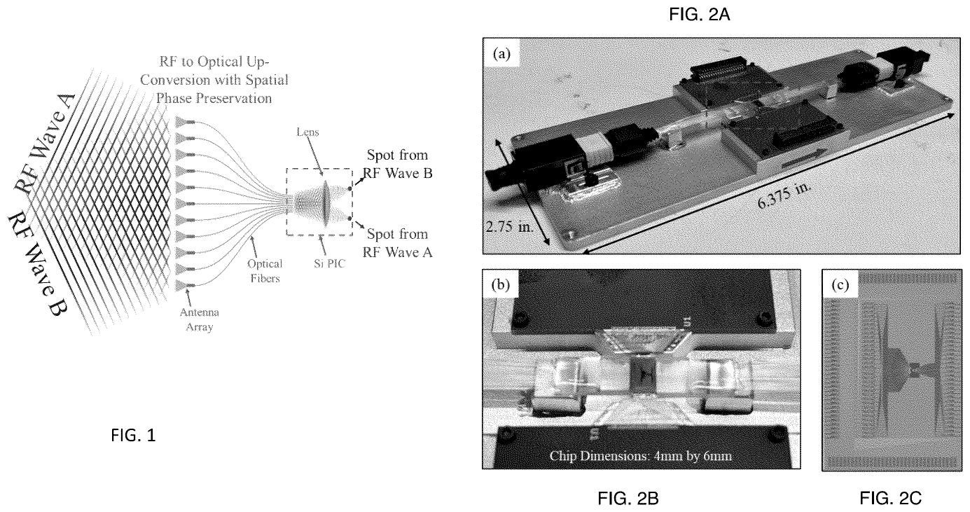

FIG. 1 is a schematic of an RF Photonic phased array system with optical processing. The silicon (or other semiconductor) beamforming PIC may perform the spatial Fourier Transform of a set of optical signals from the front-end of an RF Photonic system as shown in FIG. 1. In this case, the front-end of the RF Photonic system comprises a standard phased array antenna including a plurality of antenna elements with each antenna element connected to an optical modulator that encodes the amplitude and phase of the RF signal onto an optical carrier such that the angle of arrival of the RF signal can be processed in the optical domain using passive optical devices. The silicon beamforming PIC was designed to accept 33 optical inputs (32 optical signals and 1 optical reference signal) and provides 32 optical outputs that correspond to the angle of arrival of (or beam formed by) the optical inputs. To accomplish this, the beamforming PIC comprises two major sections: (1) phase control feedback devices and (2) a star coupler to perform the Fourier Transform. The phase control feedback section taps off a small amount of power from each incoming optical signal as well as a small amount of power from the optical reference and combines the two onto an on-chip monitor photodiode. There are 32 on-chip monitor photodiodes to provide a feedback signal for each of the input optical signals. The PIC may also include thermal phase shifters to adjust the phase of each optical signal; however, for the results presented in this paper, these phase shifters were not used.

The on-chip spatial Fourier transform is achieved using a star coupler. The star coupler comprises input waveguides, a free propagation region (an interference region such as a slab waveguide), and output waveguides. The interface between the waveguides and free propagation region may be curved such that the device acts similarly to a one-dimensional lens. The design of the star coupler and the simulation of the overall PIC performance was completed using Ansys Lumerical Photonics Simulation and Design Software.

FIG. 2A illustrates an example of a packaged Si beamforming PIC on a breakout PCB; FIG. 2B illustrates the packaged PIC; FIG. 2C shows further details of the PIC. The PIC may include optical edge couplers for coupling light into and out of the PIC, and wire bonding may provide connections to the on-chip photodiodes and thermal phase shifters. After fabrication, the silicon beamforming PIC may be packaged in an aluminum housing.

The electrical connections to the thermal phase shifters and on-chip monitor photodiodes may be wire bonded to fanout printed circuit boards (PCBs) with connectors at the package edge. Fiber arrays may be attached to both sides of the PIC for coupling optical signals into and out of the PIC.

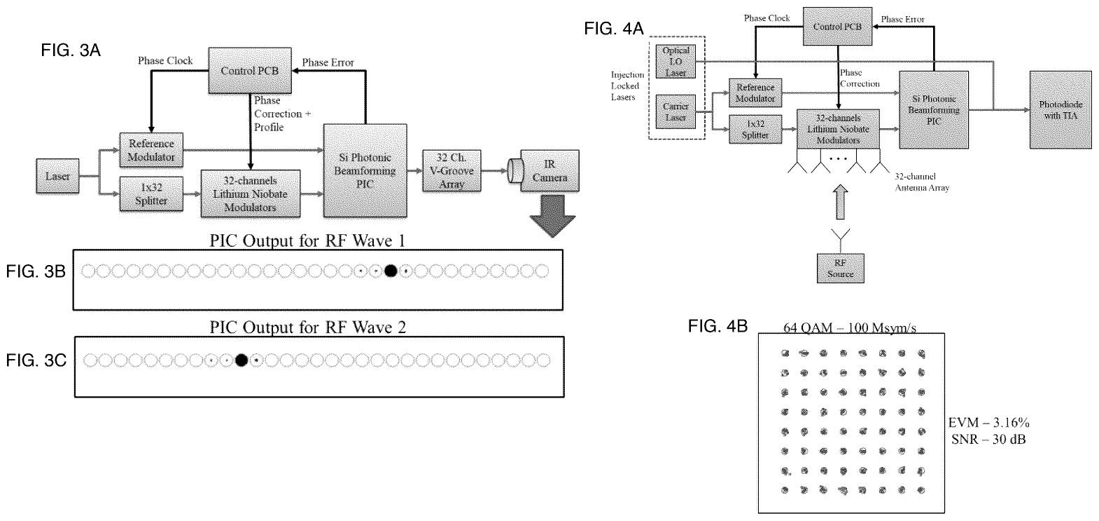

FIG. 3A is a schematic illustrating experimental setup for testing the beamforming PIC; FIG. 3B is an image from the IR camera showing a single beam formed at the output of the PIC corresponding to an RF signal with a particular angle of arrival; and FIG. 3C is another IR image for a different phase profile corresponding to a different output beam. After packaging, a manufactured PIC was first characterized according to the schematic shown in FIG. 3A. A standard DFB laser was used as an optical source. The optical source was divided using a 90/10 splitter with the 10% portion of the signal passing through a reference phase modulator before coupling onto the Si PIC as the optical phase reference signal. The 90% portion of the optical source was further split into 32 separate signals, each of which was routed through a lithium niobate optical modulator to simulate an RF Photonic system front-end. After the modulators, the optical signals were coupled into the silicon PIC. The output fiber array from the silicon PIC was connected to a fiber v-groove array (VGA) to facilitate imaging the outputs of the PIC onto an infrared (IR) camera. Each fiber imaged onto the camera corresponds to a waveguide output of the silicon PIC, and each waveguide output of the silicon PIC corresponds to one beam that can be formed by the system.

After calibration, the beam forming capability of the PIC is demonstrated as providing an optical signal to all the inputs of the PIC results in most of the light coupling to a single output of the PIC, which can be seen in the IR camera image in FIG. 3B. Furthermore, as a linear phase profile is applied across the input optical signals, the output optical signal is steered to a different output of the PIC, as shown in FIG. 3C. The phase profile across the input optical signals is analogous to the angle of arrival of an RF signal incident on a linear phased array antenna effectively illustrating the beam forming capability of the PIC.

FIG. 4A is a block diagram of an RF Photonic imaging system with the Si Photonic PIC serving as the beamforming element of the system; FIG. 4B 64-QAM shows a constellation captured at the output of the PDTIA at an IF frequency of 1 GHz after beamforming through the PIC. The PIC may be incorporated into an RF Photonic imaging system with an actual RF front-end antenna array as shown in FIG. 4A. Details of an exemplary imaging system may be found in U.S. Pat. No. 9,525,489 issued Dec. 20, 2016, the contents of which are hereby incorporated by reference. The structure and operation of the imaging system of U.S. Pat. No. 9,525,489 may be implemented with the embodiments of the present application with the modifications implemented by these embodiments. In the example of FIG. 4A, the RF-photonic imaging system includes a 32-channel RF phased array antenna connected to an array of 32 lithium niobate modulators forming the front-end of the system. Also included is a second laser source to serve as an optical local oscillator (LO) that is injection locked to the carrier laser to allow support for direct down conversion and coherent demodulation at an intermediate frequency (IF) at the output of the system. Lastly, a photodiode with a trans-impedance amplifier (PDTIA) is used to detect the beamformer output combined with the optical LO. In this experiment, an RF signal at a frequency 27 GHz with a 64 Quadrature Amplitude Modulation (QAM) encoding at 100 Msym/s was transmitted to the phased array antenna. The optical LO laser source was set to a frequency offset of 28 GHz from the carrier laser and combined with one output of the beamforming PIC (corresponding to the location of the RF source) to produce an IF signal output of 1 GHz from the PDTIA. The 1 GHz IF signal was demodulated using a high-speed oscilloscope with vector signal analysis capability. FIG. 4B shows the constellation for the 1 GHz IF signal captured from the output of the PDTIA. The constellation exhibits an error vector magnitude (EVM) of 3.16% and signal-to-noise ratio (SNR) of 30 dB.

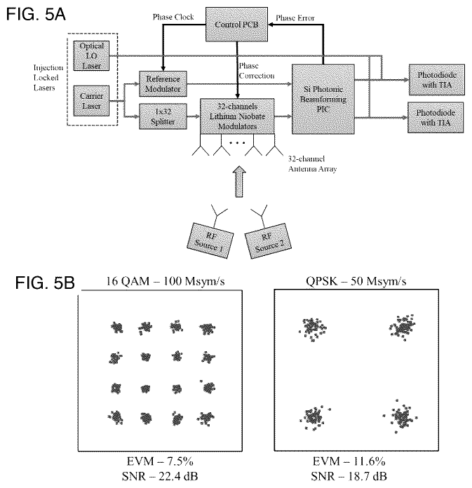

FIG. 5A is a block diagram the RF Photonic imaging system using the PIC for simultaneous beamforming of 2 RF signals; FIG. 5B illustrates IF Constellations captured at the output of the system for both RF sources. Simultaneous processing of two RF sources may be performed by the RF Photonic imaging system. An experiment was conducted according to the block diagram shown in FIG. 5A. A second RF source was used to transmit another signal at the same frequency as the first RF source. The optical LO signal was split and combined with two of the beamforming PIC outputs with each output corresponding to the location of one of the RF sources. Each of these combined signals was detected using separate PDTIAs. The output of both PDTIAs were analyzed simultaneously using two channels of the high-speed oscilloscope. To differentiate between the two RF signals, they were each encoded with different modulation formats: one with 16 QAM at 100 Msym/s and the other with quadrature phase shift keying (QPSK) at 50 Msym/s. Both signals were detected at an IF of 1 GHz. The resulting constellations, including EVM and SNR, are shown in FIG. 5B. Part of the signal degradation is attributable to the splitting of the optical LO, effectively reducing the gain of each with respect to the single source experiment. Thus, the PIC was able to simultaneously process multiple RF signals even when transmitted at the same frequency. The beamforming section of the PIC may not consume any power and may be implemented only with passive optical device(s), such as the star coupler. The only power-consuming elements on the PIC may be the monitor photodiodes, which consume a few milliwatts of power or less (e.g., less than 10 milliwatts of power). Note that more than two received RF signals (from corresponding RF sources) can be processed simultaneously. For example, the experimental PIC can simultaneously process up to 32 beams.

The silicon PIC may simultaneously process multiple RF signals in the optical domain in real time with very low power. The PIC may include optical devices to provide phase detection feedback and to perform spatial Fourier Transforms corresponding to the beamforming of RF signals detected by a phased array antenna. The beamforming on the PIC may use a passive device, i.e., the star coupler, which consumes zero power. Versions of the PIC can provide additional functionality to support more complex processing in the optical domain such as aperture apodization or spectral processing.

Although in the examples described herein, the output signals from sensing the phase perturbation were taken off chip for processing and the phase-correction feedback loop, other embodiments include appropriate on-chip circuitry (formed as a circuit of the PIC and integral with the other circuits of the PIC described herein) for performing the phase correction on the PIC.

Such on-chip circuits that may be provided on chip (may include on-chip actuators for the adjustment of the phase of optical beams propagating in the PIC, such as thermal actuators and/or carrier-depletion actuators. Thermal actuators rely on local heating of the PIC, which consumes power and is subject to cross-talk when multiple such phase-adjustment elements are on the same chip. Carrier-depletion actuators do not suffer from cross-talk and dissipate negligible (electrical) power on the PIC. However, a carrier-depletion actuator has large footprint and introduces optical loss to the optical beams propagating the PIC. Some embodiments contemplate phase adjustment using lithium niobate or equivalent that adjust phase using an electro-optic effect, which results in dissipation of negligible electrical power (as the application of electric field to the lithium niobate may avoid direct current flow) and no significant loss is incurred.

Additional on-chip circuits may include photo-detectors as well as electronic analog and digital circuits, along with analog-to-digital and digital-to-analog converters for sensing the phase, calculating the required adjustment voltage, and applying the voltage to the actuators.

### EACH OF THE FOLLOWING ARE INCORPORATED BY REFERENCE IN ITS ENTIRETY

D. W. Prather et al., “Millimeter-Wave and Sub-THz Phased-Array Imaging Systems Based on Electro-Optic Up-Conversion and Optical Beamforming,” IEEE J. Select. Topics Quantum Electron., vol. 29, no. 5: Terahertz Photonics, pp. 1-14, September 2023, doi: 10.1109/JSTQE.2023.3306953.
D. W. Prather et al., “Fourier-Optics Based Opto-Electronic Architectures for Simultaneous Multi-Band, Multi-Beam, and Wideband Transmit and Receive Phased Arrays,” IEEE Access, vol. 11, pp. 18082-18106, 2023, doi: 10.1109/ACCESS.2023.3244063.
Y. Tong, C.-W. Chow, G.-H. Chen, C.-W. Peng, C.-H. Yeh, and H. K. Tsang, “Integrated Silicon Photonics Remote Radio Frontend (RRF) for Single-Sideband (SSB) Millimeter-Wave Radio-Over-Fiber (ROF) Systems,” IEEE Photonics J., vol. 11, no. 2, pp. 1-8, April 2019, doi: 10.1109/JPHOT.2019.2898938.
D. Prather et al., “Optically Upconverted, Spatially Coherent Phased-Array-Antenna Feed Networks for Beam-Space MIMO in 5G Cellular Communications,” 2023.
D. W. Prather and C. A. Schuetz, “Photonic Integrated Circuits in RF Beamforming for Optimized 5G/6G Wireless Communications,” in 2023 IEEE Research and Applications of Photonics in Defense Conference (RAPID), Miramar Beach, FL, USA: IEEE, September 2023, pp. 1-2. doi: 10.1109/RAPID54473.2023.10264721.
U.S. Pat. No. 9,525,489 issued Dec. 20, 2016.
“Radiofrequency signal-generation system with over seven octaves of continuous tuning,” authored by Schneider et al., and published in Nature Photonics, online Jan. 20, 2013.
U.S. Pat. No. 10,965,100, issued Mar. 30, 2021

Although the embodiments of the present invention have been described, it is understood that the present invention should not be limited to these embodiments but various changes and modifications can be made by one ordinary skilled in the art within the spirit and scope of the present invention. Therefore, it should be understood that the embodiments described above are exemplary in all respects and are not intended to be limiting.

1. A semiconductor photonic integrated circuit (PIC) configured to simultaneously process multiple RF signals in the optical domain in real time with low power.

2. The semiconductor PIC of claim 1 comprising optical devices to provide phase detection feedback and/or to perform spatial Fourier Transforms corresponding to the beamforming of RF signals detected by a phased array antenna.

3. The semiconductor PIC of claim 2, wherein only passive optical devices, such as a star coupler and/or an optical lens(es), are used to perform the beamforming.

4. The semiconductor PIC of claim 3, wherein the beamforming passive optical devices consume zero power.

5. The semiconductor PIC of claim 2, wherein the PIC includes phase correction circuits.

6. The semiconductor PIC of claim 5, wherein the phase correction circuits include one or more of on-chip actuators for the adjustment of the phase of optical beams propagating in the PIC.

7. The semiconductor PIC of claim 6, wherein the on-chip actuators include as thermal actuators and/or carrier-depletion actuators.

8. The semiconductor PIC of claim 6, wherein the phase correction circuits include lithium niobate that adjust phase using an electro-optic effect.

9. The semiconductor PIC of claim 6, further comprising one or more of the following on-chip circuits: photo-detectors, electronic analog circuits, electronic digital circuits, analog-to-digital converters, digital-to-analog converters.

10. A semiconductor PIC configured to perform processing in the optical domain to perform aperture apodization and/or spectral processing.

11-12. (canceled)
